(19) United States
(12) Patent Application Publication
(10) Pub. No.: US 2014/0286737 A1
(43) Pub. Date: Sep. 25, 2014

(54) DATA STORAGE LIBRARY

(71) Applicant: Venture Corporation Limited, Singapore (SG)

(72) Inventors: Kan YANG, Singapore (SG); Hongli BAI, Singapore (SG); Chin Ting TAN, Singapore (SG); Sheau Yeng WEI, Singapore (SG); Yeow Seng VOON, Singapore (SG)

(21) Appl. No.: 14/295,328

(22) Filed: Jun. 3, 2014

Related U.S. Application Data
(63) Continuation of application No. PCT/SG12/00322, filed on Sep. 6, 2012.

(51) Int. Cl. G11B 17/22

(52) U.S. Cl. CPC G11B 17/22
USPC 414/277

(57) ABSTRACT

A data storage library comprising a stack of storage modules, each storage module comprising an array of storage slots, the data storage library comprising: a plurality of transmission robots, each transmission robot comprising a tray for transporting a data storage medium to and from a storage slot; and a transmission apparatus configured for effecting movement of at least one of the plurality of transmission robots between two adjacent storage modules in the data storage library.

### TECHNICAL FIELD

This invention relates to a data storage library, and in particular, but not exclusively, to a scalable data storage library for storing tape cartridges.

### BACKGROUND

A scalable data storage library typically comprises a stack of multiple storage modules, each storage module having an array of storage slots therein. The storage modules normally comprise a base module and a number of expansion modules.

In a prior art scalable data storage library, each storage module is provided with a transmission apparatus. The transmission apparatus typically comprises a tray supporting a transmission robot that is moved along a vertical axis of movement in order to access a plurality of storage slots within the storage module. The tray may be moved vertically by means of a rack-and-pinion system wherein positioning pinions which are attached to the tray rotatably engage vertically disposed racks which are attached to a housing of the storage module.

For a data storage medium such as a tape cartridge to be moved from a first storage module to a second storage module, the tape cartridge needs to be transferred from a first transmission apparatus in the first storage module to a second transmission apparatus in the second storage module. This may be achieved by providing a transition slot between the first storage module and the second storage module where the first transmission apparatus may place the tape cartridge to be picked up by the second transmission apparatus. This naturally slows down movement of the tape cartridge between the first and the second storage module.

Similar transition slots are provided between all the storage modules in such a scalable data storage library so that a tape cartridge may be moved anywhere within the scalable data storage library, from the base module up through to a topmost expansion module. However, such scalable data storage libraries are costly due to the multiplied cost of the transmission apparatus with each additional storage module.

In another prior art scalable data storage library, only one transmission apparatus with one loading robot is provided to serve the stack of storage modules, thus reducing the number of transmission apparatuses required. However, there are problems associated with providing only one transmission apparatus with one loading robot serving a stack of multiple storage modules. Such problems include requiring an installer or user to adjust individual racks in each storage module to achieve a desired alignment of matching racks from one storage module to the next storage module in order for the pinions on the tray to be able to rotate seamlessly and cross-over from one storage module to its vertically adjacent storage module. Without human intervention to correct mis-alignment of matching racks, the tray will be unable to make the cross-over successfully.

Besides the tray being mechanically hindered from moving from one storage module to the next due to rack misalignment, manual adjustment of racks also gives rise to cummulative stack-up errors as the number of storage modules in the stack increases. This is due to the stack of multiple library units having only one reference home flag which is normally provided at the lowest storage module that serves as a global reference for all the data storage slots in the stack of multipe storage modules. Because the cummulative stack-up errors eventually become larger than each data storage slot can tolerate, there is thus a limit to the number of storage modules that may be stacked in order to still be able to accurately access the data storage slots in the highest storage module in the stack.

### SUMMARY

According to a first aspect, there is provided a data storage library comprising a stack of storage modules, each storage module comprising an array of storage slots, the data storage library comprising: a plurality of transmission robots, each transmission robot comprising a tray for transporting a data storage medium to and from a storage slot; and a transmission apparatus configured for effecting movement of at least one of the plurality of transmission robots between two adjacent storage modules in the data storage library.

Access to at least a portion of the stack of storage modules may be made available to at least two of the plurality of transmission robots.

Access to a specific portion of the stack of storage modules is made available to only a specific one of the plurality of transmission robots.

The data storage library may further comprise a backup module configured for driving a failed one of the plurality of transmission robots to either a top or bottom surface of the data storage library for removal.

The data storage library may further comprise a transition space configured for one of the plurality of transmission robots to place a data storage medium therein for pickup by another one of the plurality of transmission robots.

The transition space may be a virtual transition space configured by a user via software.

The transition space may comprise an unused storage slot.

The transmission apparatus may comprise a plurality of positioning pinions rotatably attached to the tray; a plurality of upright frames disposed on each upright edge of each of the storage modules; a plurality of racks each disposed on each of the plurality of upright frames and configured to be engaged by the corresponding plurality of positioning pinions for vertical positioning of the tray within each storage module; a plurality of partial racks each comprising an upper tooth and a lower tooth disposed adjacent the plurality of racks at each of the plurality of upright frames, the upper tooth being disposed adjacent a lower end of the frame of each storage module and the lower tooth being disposed adjacent an upper end of the frame of each storage module; and a plurality of cross-over pinions each rotatably attached to the tray and disposed co-axially with each of the plurality of positioning pinions, each cross-over pinion having a tooth profile configured to engage each of the partial racks for effecting movement of the tray between two adjacent storage modules.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a perspective schematic view of an exemplary embodiment of a data storage library showing one transmission robot;

FIG. 2 is a schematic isometric view of a cross-over configuration provided in the data storage library FIG. 1;

FIG. 3a is another schematic isometric view of the cross-over configuration of FIG. 2;

FIG. 3b is a schematic isometric cross-sectional view of a bearing in the cross-over configuration of FIG. 3a;

FIG. 3c is a schematic isometric cross-sectional view of a positioning pinion in the cross-over configuration of FIG. 3a;

FIG. 3d is a schematic isometric cross-sectional view of a cross-over pinion and rack in the cross-over configuration of FIG. 3a;

FIG. 4a is a schematic side view of the bearing of FIG. 3b when the positioning pinion of

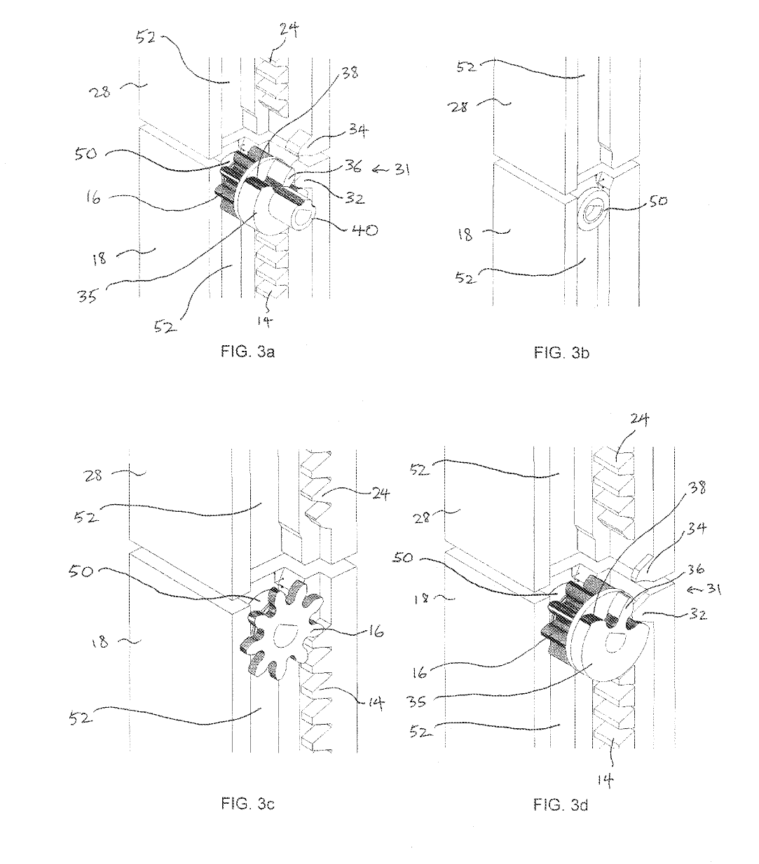

FIG. 3c is preparing to transfer power transmission to the cross-over pinion of FIG. 3d;

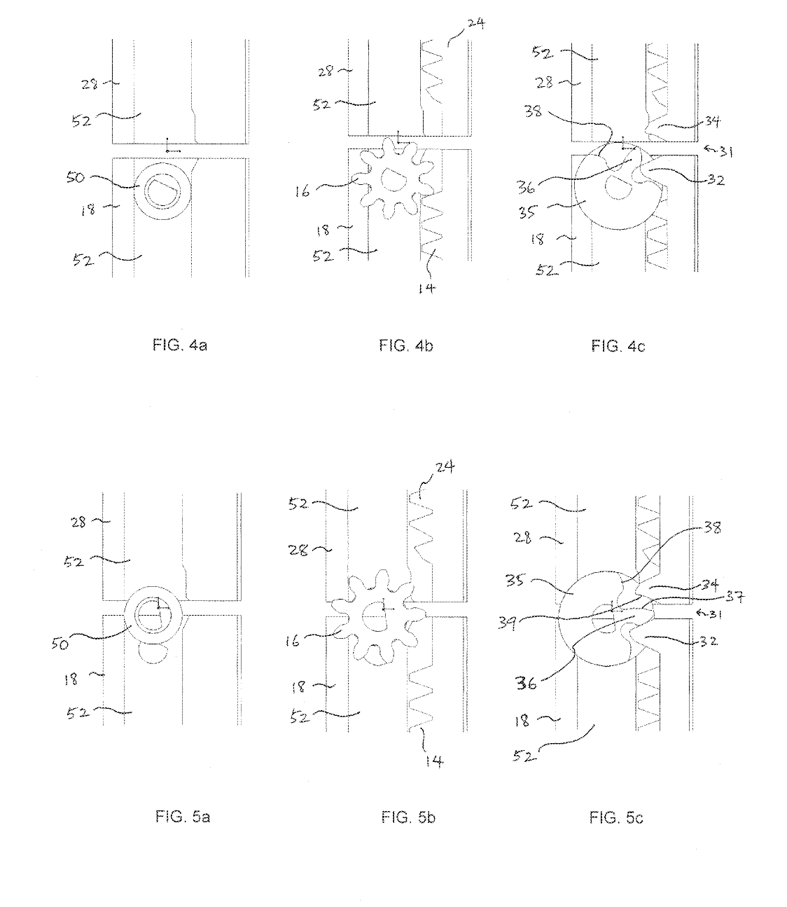

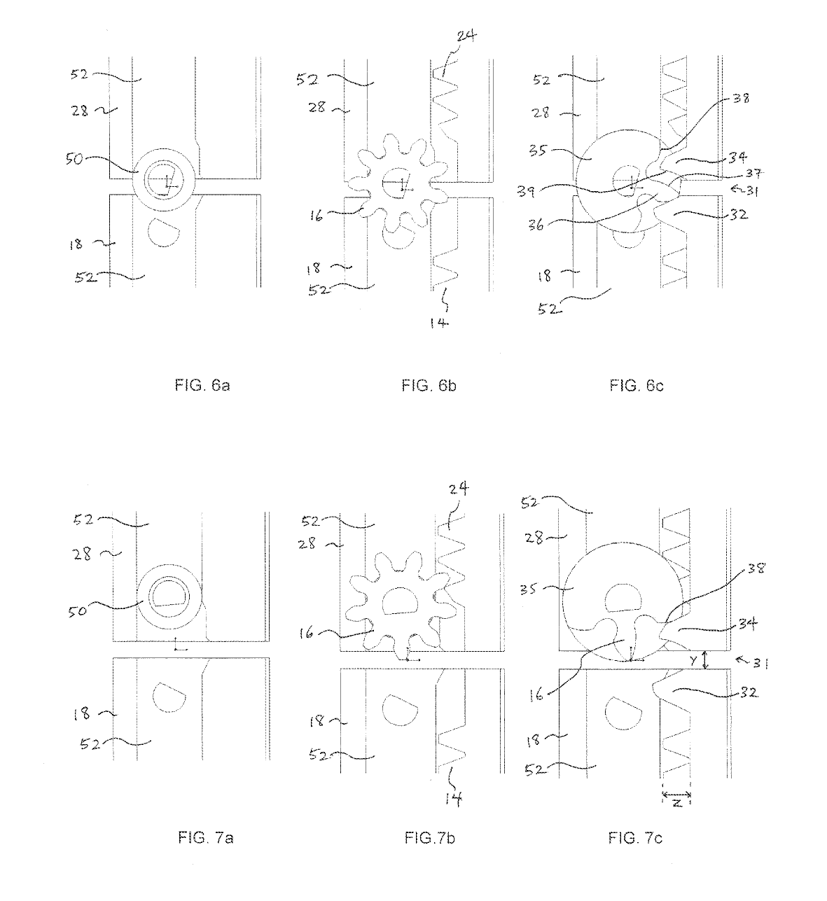

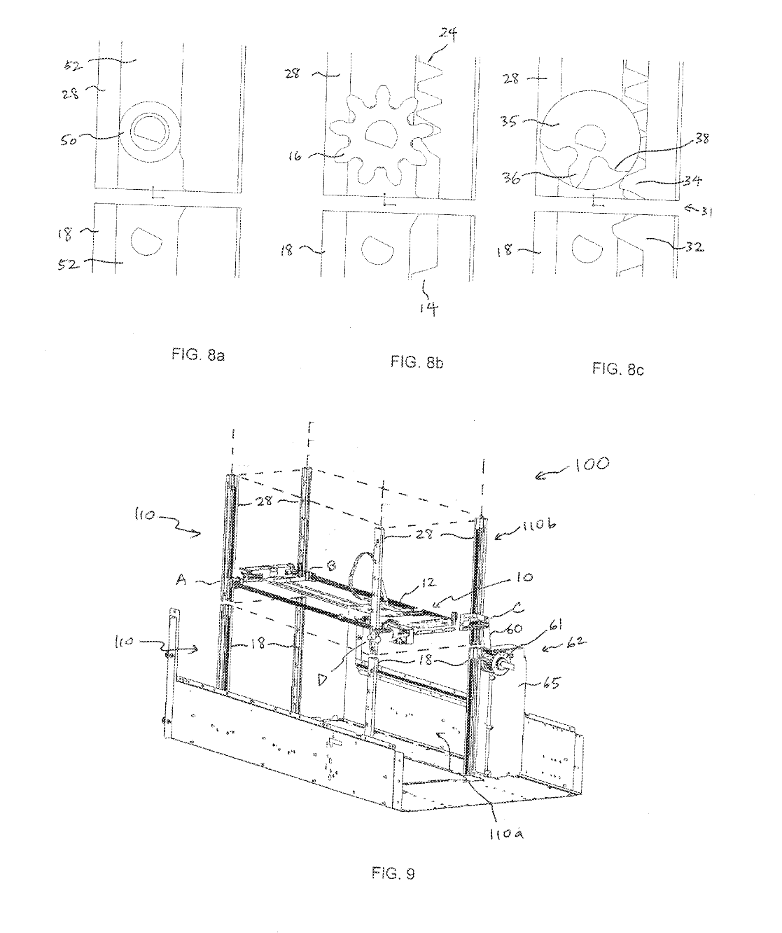

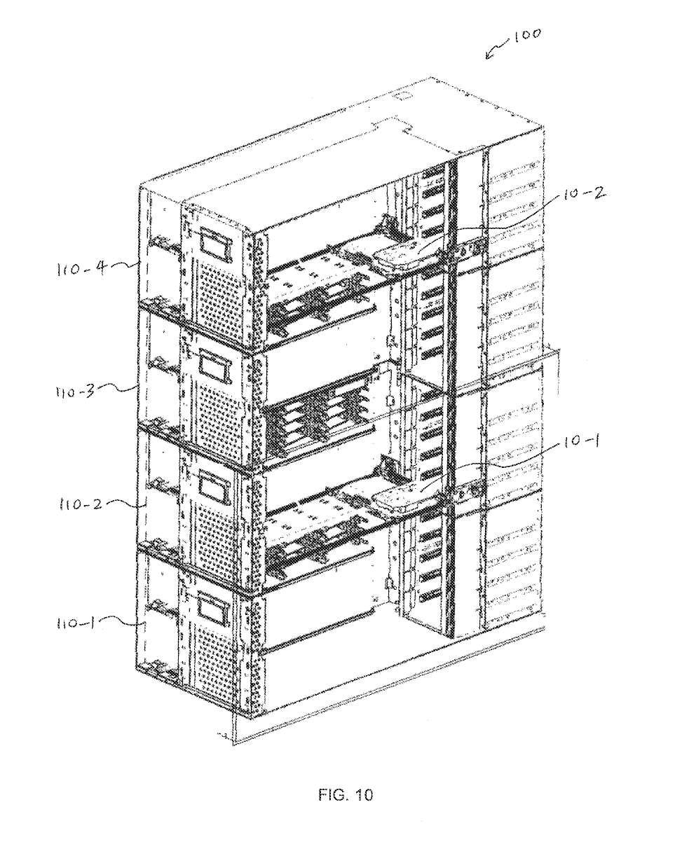

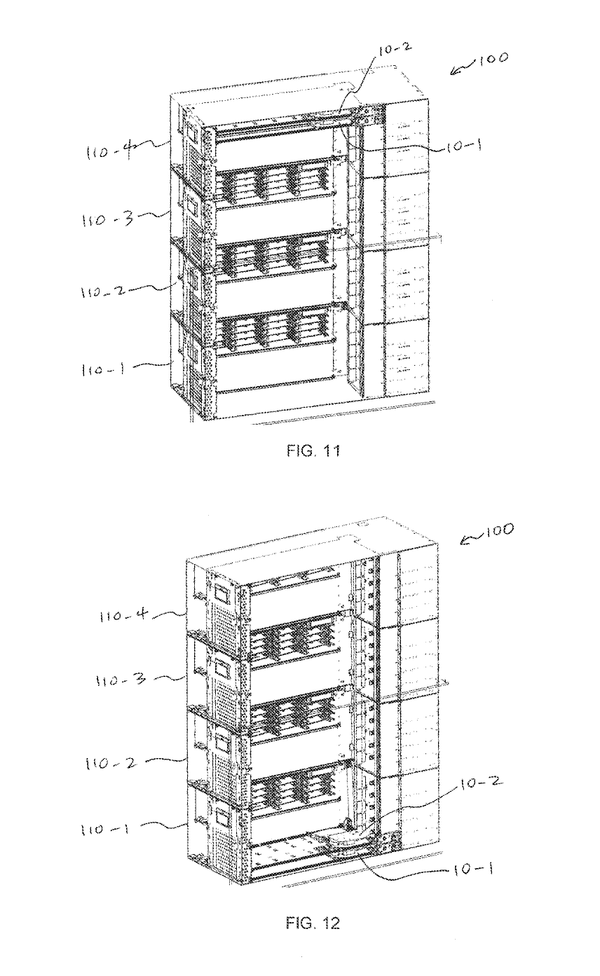

FIG. 4b is a schematic side view of the positioning pinion of FIG. 3c when the positioning pinion of FIG. 3c is preparing to transfer power transmission to the cross-over pinion of FIG. 3d;

FIG. 4c is a schematic side view of the cross-over pinion of FIG. 3d when the positioning pinion of FIG. 3c is preparing to transfer power transmission to the cross-over pinion of FIG. 3d;

FIG. 5a is a schematic side view of the bearing of FIG. 3b when the cross-over pinion of FIG. 3d is engaged to effect the cross-over from a lower storage module to an upper storage module;

FIG. 5b is a schematic side view of the positioning pinion of FIG. 3c when the cross-over pinion of FIG. 3d is engaged to effect the cross-over from a lower storage module to an upper storage module;

FIG. 5c is a schematic side view of the cross-over pinion of FIG. 3d when the cross-over pinion of FIG. 3d is engaged to effect the cross-over from a lower storage module to an upper storage module;

FIG. 6a is a schematic side view of the bearing of FIG. 3b during the cross-over from a lower storage module to an upper storage module;

FIG. 6b is a schematic side view of the positioning pinion of FIG. 3c during the cross-over from a lower storage module to an upper storage module;

FIG. 6c is a schematic side view of the cross-over pinion of FIG. 3d during the cross-over from a lower storage module to an upper storage module;

FIG. 7a is a schematic side view of the bearing of FIG. 3b when the positioning pinion of FIG. 3c is preparing to resume power transmission;

FIG. 7b is a schematic side view of the positioning pinion of FIG. 3c when the positioning pinion of FIG. 3c is preparing to resume power transmission;

FIG. 7c is a schematic side view of the cross-over pinion of FIG. 3d when the positioning pinion of FIG. 3c is preparing to resume power transmission;

FIG. 8a is a schematic side view of the bearing of FIG. 3b when the positioning pinion of FIG. 3c has resumed power transmission;

FIG. 8b is a schematic side view of the positioning pinion of FIG. 3c when the positioning pinion of FIG. 3c has resumed power transmission;

FIG. 8c is a schematic side view of the cross-over pinion of FIG. 3d when the positioning pinion of FIG. 3c has resumed power transmission;

FIG. 9 is a schematic isometric view of one transmission robot in a stack of storage modules;

FIG. 10 is a schematic cutaway isometric view of a data storage library having a plurality of transmission robots;

FIG. 11 is a schematic cutaway perspective view of the data storage library of FIG. 10 with the plurality of transmission robots in a top-most position; and

FIG. 12 is a schematic cutaway perspective view of the data storage library of FIG. 10 with the plurality of transmission robots in a bottom-most position.

### DETAILED DESCRIPTION OF EXEMPLARY EMBODIMENTS

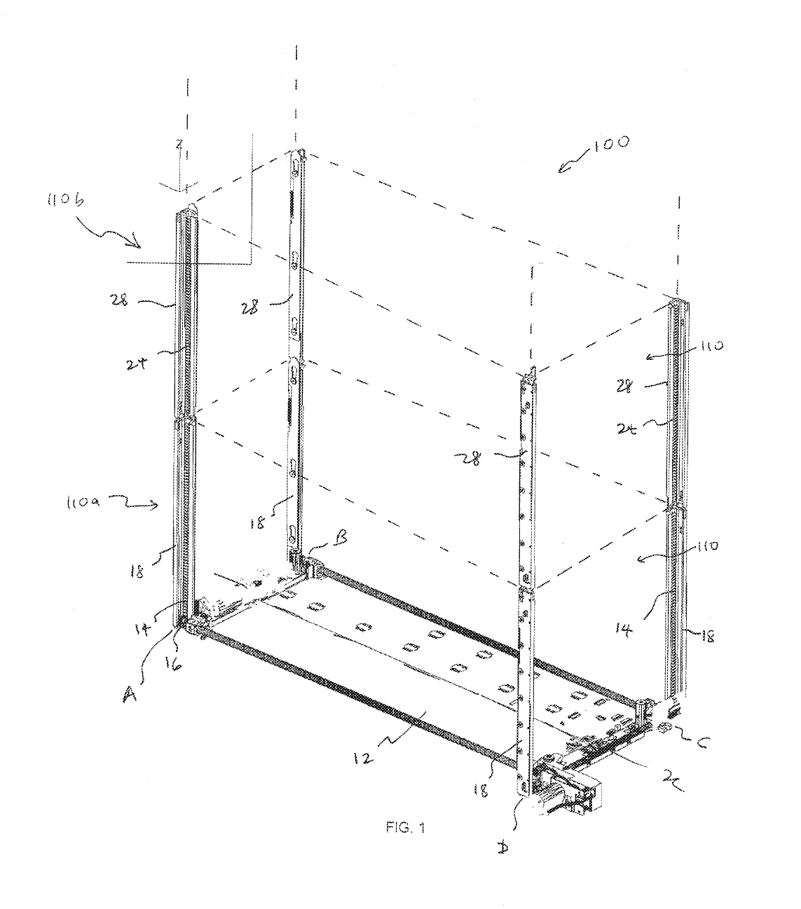

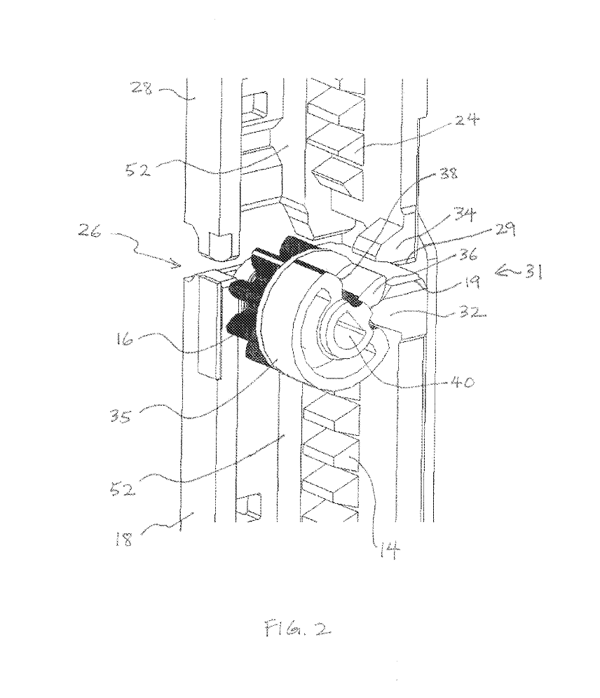

An exemplary data storage library 100 will be described with reference to FIGS. 1 to 10 below.

The data storage library 100 comprises a stack of storage modules 110 and a plurality of transmission robots 10. Each transmission robot 10 includes a rectangular tray 12 for transporting a data storage medium thereon within the data storage library 100. Examples of the data storage medium include a tape cartridge or storage disk. The data storage library 100 also comprises a transmission apparatus configured for effecting movement of at least one of the transmission robots 10 between adjacent storage modules 110 in the data storage library 100.

The transmission apparatus comprises four upright or vertically disposed racks 14 or 24 at corresponding four corners of each storage module 110 of the data storage library 100. The racks 14, 24 are configured to be engaged by positioning pinions 16 rotatably therealong. Each rack 14, 24 is mounted to and supported by an upright or vertically disposed frame 18, 28 of a storage module 110. The frames 18, 28 may be of any suitable material or shape provided they are substantially rigid, given their purpose.

The transmission apparatus also comprises a positioning pinion 16 at, immediately adjacent, adjacent or near each of the four corners A, B, C, D of each tray 12 of the plurality of transmission robots 10. Each tray 12 thus has four positioning pinions 16 rotatably attached thereto. The four positioning pinions 16 are configured to rotatably engage the racks 14, 24 for effecting movement and precise positioning of the tray 12 within that storage module 110.

As can be seen, for two adjacent storage modules 110a, 110b, the racks 14 of a lower storage module 110a match up with the racks 24 of adjacent upper storage module 110b in order to allow the positioning pinions 16 to move between the lower and upper storage modules 110a, 110b.

To overcome the need for precise manual adjustment to the alignment between adjacent racks 14,24, the transmission apparatus further comprises a cross-over configuration provided at each of the four corners between adjacent storage modules 110a, 110b in the data storage library 100, as shown in FIG. 2. The cross-over configuration 30 comprises a partial rack-and-pinion profile. This includes a partial rack 31 provided alongside the racks 14, 24 and adjacent the meeting ends 19, 29 of each frame 18, 28 respectively. The partial rack 31 comprises a lower tooth 32 and an upper tooth 34. The lower tooth 32 is provided at the upper end 19 of the frame 18 of the lower storage module 110a, while the upper tooth 34 is provided at the lower end 29 of the frame 28 of the upper storage module 110b. The lower tooth 32 and upper tooth 34 have profiles configured to engage a tooth 36 and an adjacent tooth surface 38 of a partial pinion gear or cross-over pinion 35 that is comprised in the cross-over configuration 30.

Each cross-over pinion 35 is attached to the corner A, B, C and D of the tray 12 and configured to be coaxial with a corresponding positioning pinion 16, and to also corotate with the positioning pinion 16. Preferably, a single shaft 40 is provided to drive both the positioning pinion 16 and the cross-over pinion 35. The positioning pinion 16 and the cross-over pinion 35 may be integrally formed with each other in order to be provided as a single compound spur gear 26 at ecah corner of the tray 12. Adjacent where the partial rack 31 is located, the racks 14, 24 are configured to be toothless so as to cease engagement with the positioning pinion 16 when the cross-over configuration 30 is effecting movement of the tray 12 between adjacent storage modules 110.

The shaft 40 is preferably constrained to move vertically at an optimal horizontal distance from the racks 14, 24 in order to achieve the greatest power transmission possible during movement of the tray 12. This may be achieved by providing a bearing 50 as shown in FIGS. 3b, 4a, 5a, 6a, 7a and 8a that is preferably also mounted on the shaft 40 and coaxial with the positioning pinion 16 and cross-over pinion 35. The bearing 50 is configured to engage a vertical surface 52 provided in each of the frames 18, 28, thereby maintaining the optimal horizontal distance mentioned above. The vertical surface 52 may be provided by means of a slot 52 provided in the frames 18, 28. Preferably, the bearing 50 is configured to have a rolling engagement with the vertical surface 52 to minimize frictional losses.

As shown in FIGS. 4a to 4c, when the tray 12 (hidden) is moving up and is at the top of a lower storage module 110a having racks 14, the positioning pinion 16 is at a point of the rack 14 where the rack 14 just ceases to have any teeth. At the same time, the cross-over pinion 35 is at a point where the single tooth 36 is at a point of first engagement with the lower tooth 32 of the partial rack 31. As the shaft 40 continues to rotate to move the tray 12 upwards, the tooth 36 of the cross-over pinion 35 engages the lower tooth 32 of the partial rack 31 to push the tray 12 upwards, thereby crossing over from the lower storage module 110a to the upper storage module 110b as shown in FIGS. 5c and 6c. During the crossing over, the positioning pinion 16 is free from engagement with any teeth of the racks 14, 24, as shown in FIGS. 5b and 6b. The bearing 50 continues to be slideably constrained by the vertical slot 52 of the frames 18, 28 to maintain an optimal horizontal distance between the positioning pinions 16 and the racks 14, 24, as shown in FIGS. 5a and 6a.

When the crossing over is just completed as shown in FIGS. 7a to 7c, the bearing 50 now engages the vertical slot 52 provided in the frame 28 of the upper storage module 110b to maintain the optimal horizontal distance. The positioning pinion 16 is at a point of first engagement with the teeth of the rack 24 of the upper storage module 110b in readiness to take over power transmission from the cross-over pinion 35. The tooth 36 of the cross-over pinion 35 has disengaged with the lower tooth 32 of the partial rack 31, while the tooth surface 38 which was in engagement with the upper tooth 34 of the partial rack 31 has now reached an end of its gear profile.

As the tray 12 moves fully into the upper storage module 110b after crossing over has been effected, as can be seen in FIGS. 8a to 8c, the positioning pinion 16 engages the rack 24 of the upper storage module 110b to take over normal movement and positioning within the upper storage module. The cross-over configuration 30 ceases to function, there being no longer any engagement or meshing between the cross-over pinion 35 and the partial rack 31.

The partial rack 31 and pinion 35 gear profile has the following characteristics to tolerate a much larger misalignement between the two rack teeth 32, 34:

A) larger gear module and pressure angle; and

B) reduced material at coast side 37, 39 that gives rise to bigger backlash.

These characteristics are important to compensate for the inherent misalignment and tolerance stack where the two rack teeth 32, 34 meet.

### A) Larger Gear Module and Pressure Angle

In order to tolerate variation in pitch to pitch distance of the rack teeth 32, 34, it is important to keep the norminal pitch distance as large as possible. In one embodiment, the ratio of tolerance stack and norminal pitch distance was kept at not greater than 0.33 as shown in equation (1) below.

$$\frac{Tolerance Stack}{Norminal Pitch Distance} = \frac{ɛ}{ρ} \leq ∼ 0.33 \qquad ( 1 )$$

A larger pressure angle of 25 degrees is used instead of the more common 20 degrees. This pressure angle of 25 degrees allows a more generous entry angle of gear mesh between the cross-over pinion tooth 36 and the partial rack lower tooth 32. The surface stress is also reduced, thereby reducing wear rate due to sliding motion. However, a much larger pressure angle is not suitable as it undesirably decreases the top land width.

B) Reduced Material at Coast Side 37, 39 that Gives Rise to Bigger Backlash

The cross-over configuration 30 relies on gravitational force to keep the cross-over pinion 35 to be always driven on a single side of the involute profile of its tooth flank. This allows deviation in the involute profile on a coast side 37 or upper tooth surface 37 of the cross-over pinion 35, as shown in FIGS. 5c and 6c. This reduction in material is necessary to allow a smaller pitch to pitch distance y between the teeth 32, 34 of the partial rack 31.

Similarly, material reduction at a coast side 39 or lower surface 39 of the upper tooth 34 of the partial rack 31 is introduced as shown in FIGS. 5c and 6c. This reduction is to avoid any interference between the cross-over pinion tooth 36 and the upper tooth 34 of the partial rack 31 when a pitch distance y between the teeth 32, 34 of the partial rack 31 is at its smallest or minimized.

Experiments were conducted to study and characterize the operation and mechanism of the cross-over configuration 30 by using a jig which was capable of changing the pitch to pitch distance between the teeth 32, 34 of the partial rack 31. A total of 8 hypothetical scenarios or worst cases were studied as shown in Table 1 below, where Y Gap refers to the pitch distance y as shown in FIG. 7c, while Z-offset is the distance z as shown in FIG. 7c.

TABLE 1

| | Front Right | | Front Left | | Rear Right | | Rear Left | |
|---|---|---|---|---|---|---|---|---|
| Configuration No. | Y Gap | Z-offset | Y Gap | Z-offset | Y Gap | Z-offset | Y Gap | Z-offset |
| WC1 | 1 | −0.5 | 1 | +0.5 | 1 | −0.5 | 1 | −0.5 |
| WC2 | 1 | +0.5 | 1 | −0.5 | 1 | +0.5 | 1 | +0.5 |
| WC3 | 3 | −0.5 | 3 | +0.5 | 3 | −0.5 | 3 | −0.5 |
| WC4 | 3 | +0.5 | 3 | −0.5 | 3 | +0.5 | 3 | +0.5 |
| WC5 | 3 | −0.5 | 3 | +0.5 | 1 | −0.5 | 1 | −0.5 |
| WC6 | 3 | +0.5 | 3 | −0.5 | 1 | +0.5 | 1 | +0.5 |
| WC7 | 1 | −0.5 | 1 | +0.5 | 3 | −0.5 | 3 | −0.5 |
| WC8 | 1 | +0.5 | 1 | −0.5 | 3 | +0.5 | 3 | +0.5 |

The characterization results were found to be satisfactory, with the cross-over configuration 30 having a working reliability of over 150K cycles.

By providing two rack-and-pinion systems 14,24-16 and 31-35 running coaxially, cumulative stack up errors previously experienced can be avoided by not relying on only one global reference as used in the prior art. Instead, individual racks 14 or 24 in each storage module 110 can take its own position with reference to its own home flag within its own storage module 110 instead of with reference to a single global reference located at a base module in the data storage library 100. Since each storage module 110 has its own home flag, each of the plurality of transmission robots 10 can take reference from that home flag when moving within that storage module 110. In this way, the stack of storage modules 110 functions as if they were independent storage modules 110, but served by the plurality of transmission robots 10.

This also minimizes reconstruction and part replacement of existing transmission robots used in unitary data storage libraries having only one storage module when the transmission robot 10 is to be adapted for use in a scalable data storage library 100 having a stack of storage modules 110 and a plurality of transmission robots 10. Similarly, reconstruction and part replacement in existing unitary data storage libraries can also be minimized since such single storage modules already come with reference features such as a reference home flag on the chassis, a reference fiducial target on some magazine slot, and an advanced non-contact optical sensing solution on the transmission robot 10. The present invention thus allows reuse of these reference features by creating a bridge between two independent storage modules 110a, 110b. In addition, an encoder sensor is preferably provided to work with the corresponding flag of each storage module 110 in order to tell a control system whether a transmission robot 10 is inside or working within the racks 14 or 24 of the storage module 110, or at the cross-over region between two storage modules 110a, 110b.

Within the data storage library 100 comprising a stack of storage modules 110, the plurality of robots 10 together have access to all the available storage slots within the full vertical height of the data storage library 100.

In one exemplary configuration, access to all the storage slots may be distributed between the plurality of transmission robots 10 such that access to at least a portion of the stack of storage modules 110 is made available to at least two of the plurality of transmission robots 10. Thus, two or more transmission robots 10 may overlap their areas of travel within the data storage library 100. In, this way, no one transmission robot 10 is overloaded and product life of the data storage library 100 may thus be extended by distributing For example, where the data storage library 100 comprises four storage modules 110-1, 110-2, 110-3, 110-4 and two transmission robots 10-1, 10-2 as depicted in FIG. 10, access to the middle two adjacent storage modules 110-2, 110-3 is available to both transmission robots 10-1, 10-2. In addition, access to some portions of the top storage module 110-4 and the bottom storage module 110-1 can also be available to both transmission robots 10-1, 10-2, with the exception of the top-most row of storage slots 114 and bottom-most row of storage slots 111 that are accessible only only by the top transmission robot 10-2 and bottom transmission robot 10-1 respectively. This is because the transmission robots 10-1, 10-2 are physical obstructions to each other when at the top end 102 and bottom end 101 of the data storage library 100 as shown in FIGS. 11 and 12.

In an alternative or additional configuration, access to specific storage modules 110 within the data storage library 100 may also be allocated to specific one or more of the plurality of transmission robots 10 in order to adjust access speed within the various storage modules 110 in the data storage library 100. For example, in the same data storage library 100 having four storage modules 110-1, 110-2, 110-3, 110-4 and two transmission robots 10-1, 10-2 as shown in FIG. 10, the first transmission robot 10-1 may be configured to access three of the storage modules 110-1, 110-2, 110-3 while the second transmission robot 10-2 is configured to access only one storage module 110-4. In this way, the second transmission robot 10-2 will be perceived to have higher performance in terms of speed of access than the first transmission robot 10-1 since the second transmission robot 10-2 travels shorter distances within one storage module 110-4 compared to the first transmission robot 10-1 travelling within three storage modules 110-1, 110-2, 110-3.

Since the transmission apparatus described above in principle allows each transmission robot 10 to move between any two adjacent storage modules 110a, 110b within the data storage library 100, each transmission robot 10 is theoretically capable of moving through all the storage modules 110 and traversing the full height of the data storage library 100 when not obstructed by other transmission robots 10 within the data storage library 100. Redundancy and backup of transmission robots 10 is thus provided in the data storage library 100 by allowing the plurality of transmission robots 10 some overlap in their individual areas of access within the data storage library 100. Thus, in case of failure of any one of the transmission robots 10, one or more of the remaining transmission robots 10 will be able to take over and access those storage modules normally accessed by the failed transmission robot 10.

Preferably, the data storage library 100 comprises a backup module that allows a user to manually remove the failed transmission robot 10 without having to power down the entire data storage library 100. The backup module is preferably battery powered, and more preferably powered by rechargeable battery having charging and discharging capability within the data storage library 100. The backup module is preferably configured to be activated with a user-activated switch. Upon activation, the backup module takes over control to drive the failed transmission robot 10 to either a top or bottom surface of the data storage library 100 for removal by the user.

As there may be instances where a data storage medium is required to be transferred from one transmission robot 10 to another transmission robot 10 within the data storage library 100, for example to reach a storage slot at a very top or bottom of the data storage library 100 which can only be accessed by the top-most or bottom-most transmission robots 10 respectively, the data storage library 100 is configured to provide at least one transition space where one transmission robot 10 may place the data storage medium to be picked up by another transmission robot 10. The transition space may be a dedicated one, for example a slot within a magazine, a space configured for placement of the data storage medium thereon, or an unused drive slot; alternatively the transition space may be a virtual one configured by a user via software to utilize any suitably configured transition space or one of the unused storage slots within the data storage library 100.

Whilst there has been described in the foregoing description exemplary embodiments of the present invention, it will be understood by those skilled in the technology concerned that many variations in details of design, construction and/or operation may be made without departing from the present invention. For example, besides tape cartridges, the data storage media may be storage discs or any other data storage media suitable for reliable, long term and readily retrievable data storage.

1. A data storage library comprising a stack of storage modules, each storage module comprising an array of storage slots, the data storage library comprising:
a plurality of transmission robots, each transmission robot comprising a tray for transporting a data storage medium to and from a storage slot; and
a transmission apparatus configured for effecting movement of at least one of the plurality of transmission robots between two adjacent storage modules in the data storage library.

2. The data storage library of claim 1, wherein access to at least a portion of the stack of storage modules is made available to at least two of the plurality of transmission robots.

3. The data storage library of claim 1, wherein access to a specific portion of the stack of storage modules is made available to only a specific one of the plurality of transmission robots.

4. The data storage library of claim 1, further comprising a backup module configured for driving a failed one of the plurality of transmission robots to either a top or bottom surface of the data storage library for removal.

5. The data storage library of claim 1, further comprising a transition space configured for one of the plurality of transmission robots to place a data storage medium therein for pickup by another one of the plurality of transmission robots.

6. The data storage library of claim 5, wherein the transition space is a virtual transition space configured by a user via software.

7. The data storage library of claim 5, wherein the transition space comprises an unused storage slot.

8. The data storage library of claim 1, wherein the transmission apparatus comprises:
a plurality of positioning pinions rotatably attached to the tray;
a plurality of upright frames disposed on each upright edge of each of the storage modules;
a plurality of racks each disposed on each of the plurality of upright frames and configured to be engaged by the corresponding plurality of positioning pinions for vertical positioning of the tray within each storage module;
a plurality of partial racks each comprising an upper tooth and a lower tooth disposed adjacent the plurality of racks at each of the plurality of upright frames, the upper tooth being disposed adjacent a lower end of the frame of each storage module and the lower tooth being disposed adjacent an upper end of the frame of each storage module; and
a plurality of cross-over pinions each rotatably attached to the tray and disposed co-axially with each of the plurality of positioning pinions, each cross-over pinion having a tooth profile configured to engage each of the partial racks for effecting movement of the tray between two adjacent storage modules.
